(19) United States
(12) Patent Application Publication
(10) Pub. No.: US 2008/0083470 A1
(43) Pub. Date: Apr. 10, 2008

(54) Hydraulic pipe for transporting a cooling liquid

(75) Inventor: Cyrielle Cheng, Saint-Jean De Monts (FR)

Correspondence Address: BIRCH STEWART KOLASCH & BIRCH, PO BOX 747, FALLS CHURCH, VA, 22040-0747, US

(73) Assignee: NOBEL PLASTIQUES

(21) Appl. No.: 11/898,154

(22) Filed: Sep. 10, 2007

(30) Foreign Application Priority Data
Oct. 10, 2006 (FR) 06 08855

(51) Int. Cl. F16L 9/14

(52) U.S. Cl. 138/141; 138/137

(57) ABSTRACT

A hydraulic pipe comprising an inner layer of polyphthalamide and an outer layer of thermoplastic material, the pipe having its thickness formed mainly by the thickness of the inner layer.

The present invention relates to a hydraulic pipe usable for example in an engine for transporting a liquid for cooling transmission oil.

### BACKGROUND OF THE INVENTION

There exist numerous pipe structures suitable for transporting a liquid under pressure under the conditions of use that are specific to a motor vehicle. Given the severity of those conditions, in terms of mechanical, chemical, physical, and thermal resistance all required simultaneously, no structure has yet been found that is completely satisfactory, particularly since those severe conditions of use are also associated with requirements in terms of cost and ease of manufacture. The search for a solution providing an ideal compromise has nevertheless involved numerous materials going from metals to elastomer and passing via thermoplastics.

As an example of the constraints involved, the operation of automatic gearboxes for motor vehicles leads to the transmission fluid heating, and that can damage automatic gearboxes. It is therefore common practice to provide a cooler fitted to the hydraulic circuit associated with the automatic gearbox. The gearbox and the cooler are connected by a pipe that must withstand temperatures lying in the range −40° C. to 150° C., pressures lying in the range 10 bars to 40 bars, chemicals with which the pipe might come occasionally into contact (oils, saline solutions, engine protection liquids, battery acids, . . . ) and mechanical forces (flapping, impacts, vibration, amongst others). The pipes presently in use for conveying the cooling liquid for transmission oil are metal pipes or rubber pipes associated with a metal braid. Nevertheless, such pipes are relatively expensive, sensitive to corrosion, not very flexible, and heavy. For those reasons, it has been envisaged to make use of pipes made of thermoplastic material, and more particularly out of polyamide 12, however that material cannot withstand temperatures above 120° C. In addition, such pipes are sensitive to moisture which can reduce the performance thereof.

### OBJECT OF THE INVENTION

The invention seeks to propose an alternative to existing structures providing a satisfactory response to the various constraints associated with being used, in particular on a motor vehicle.

### SUMMARY OF THE INVENTION

To this end, the invention provides a hydraulic pipe comprising a layer of polyphthalamide and at least one layer of another thermoplastic material, the pipe having thickness that is formed mainly by the thickness of the layer of polyphthalamide.

Thus, the pipe has a thickness that is mainly or mostly formed by the thickness of the layer polyphthalamide that provides the majority of the low permeability of the pipe and the ability of the pipe to withstand mechanical stress, chemical attack, and physical and thermal stresses. The other thermoplastic material is selected to provide protection for the polyphthalamide and/or to improve its performance. Such a pipe can then present low permeability, be flexible, lightweight, insensitive to corrosion, and resistant to fatigue. Furthermore, polyphthalamide tends to be plastically deformable when cold and presents little mechanical elongation. The thermoplastic material is then selected to improve the mechanical elongation and to provide the pipe with its stiffness and its elasticity so as to provide a pipe that is relatively flexible and elastically deformable.

The layer of polyphthalamide is preferably the innermost layer of the tube.

It is advantageous for the polyphthalamide to be in contact with the fluid being transported, given its ability to withstand chemical attack.

In a particular embodiment, the thickness of the layer of polyphthalamide is five to ten times greater than the thickness of the layer of thermoplastic material, and preferably the thickness of the layer of polyphthalamide is about 1 millimeter (mm) to 1.5 mm and the thickness of the layer of thermoplastic material is about 0.2 mm.

This thickness ratio is the optimum solution for making a pipe in accordance with the invention.

According to an advantageous characteristic, the layer of thermoplastic material is of a fluoropolymer, and preferably the fluoropolymer is a terpolymer of tetrafluoroethylene, hexafluoropropylene, and fluorinated vinylidene.

The layer of fluoropolymer thus provides the pipe with good protection against external attack without interfering with the flexibility of said pipe. The fluoropolymer also presents the advantage of being hydrophobic so it prevents water contaminating the fluid being transported. The fluoropolymer also presents excellent ability to withstand temperatures up to a temperature of about 165° C.

In a variant, the layer of thermoplastic material is a thermoplastic elastomer.

The layer of thermoplastic elastomer also provides the pipe with good protection against external aggression without interfering with the flexibility of said pipe.

Other characteristics and advantages of the invention appear on reading the following description of particular, non-limiting embodiments of the invention.

### DETAILED DESCRIPTION OF THE INVENTION

The pipe in accordance with the invention comprises an inner layer made of polyphthalamide (PPA) having thickness lying in the range 1 mm to 1.5 mm.

The pipe also comprises an outer layer made of a fluoropolymer and preferably of a terpolymer of tetrafluoroethylene, hexafluoropropylene, and fluorinated vinylidene (THV). Other fluoropolymers can be used, such as: polyvinylidene fluoride (PVDF); ethylene tetrafluoroethylene (ETFE); ethylene fluoroethylene perfluoride (EFEP); polytetrafluoroethylene (PTFE); fluoroethylene propylene (FEP); perfluoroalkoxy (PFA); ethylene chlorotrifluoroethylene (ECTFE); . . . The outer layer has a thickness of about 0.2 mm.

The thickness of the pipe is formed mostly by the thickness of the layer of polyphthalamide.

The pipe in accordance with the invention is made by extrusion and the outer layer is in direct contact with the inner layer. This is made possible by the good properties of mutual adhesion between polyphthalamide and the fluoroterpolymer.

In a variant, when these adhesive properties are not sufficient given the conditions of use of the pipe, it is possible to add a bonding layer between the inner layer and the outer layer.

In another variant, it is possible to make the outer layer out of a thermoplastic elastomer (TPE) presenting properties similar to the fluoropolymer in terms of temperature and pressure, but being more flexible.

Naturally, the invention is not limited to the embodiment described and variant embodiments can be provided without going beyond the ambit of the invention as defined by the claims.

The pipe may have more than two layers and the order of the layers may be changed.

The materials used may include fillers or additives, e.g. to make them mutually compatible (improving their adhesion) or conductive, or providing mechanical reinforcement or color, . . . .

What is claimed is:

1. A hydraulic pipe comprising a layer comprising mostly polyphthalamide and at least one layer of another thermoplastic material, the pipe having thickness that is formed mainly by the thickness of the layer of polyphthalamide.

2. A pipe according to claim 1, in which the thickness of the layer of polyphthalamide is five to ten times greater than the thickness of the layer of thermoplastic material.

3. A pipe according to claim 2, in which the thickness of the layer of polyphthalamide is about 1 mm to 1.5 mm, and the thickness of the layer of thermoplastic material is about 0.2 mm.

4. A pipe according to claim 1, in which the outer layer of thermoplastic material is made of a thermoplastic elastomer.

5. A pipe according to claim 1, in which the outer layer of thermoplastic elastomer is made of a fluoropolymer.

6. A pipe according to claim 5, in which the fluoropolymer is a terpolymer of tetrafluoroethylene, hexafluoropropylene, and fluorinated vinylidene.

7. A pipe according to claim 1, in which the layer of thermoplastic material is directly in contact with the layer of polyphthalamide.

8. A pipe according to claim 2, in which the layer of polyphthalamide is the innermost layer of the tube.
